(19) United States
(12) Patent Application Publication
(10) Pub. No.: US 2011/0315752 A1
(43) Pub. Date: Dec. 29, 2011

(54) EXPANDABLE STAR PINATA

(76) Inventors: Loan Kieu Thi Huynh, San Jose, CA (US); Sarah Jean Johnston, Folsom, CA (US); Christian Alejandro Carrillo, Chula Vista, CA (US); Jagjit Singh, San Luis Obispo, CA (US); Evan Antone Cernokus, San Luis Obispo, CA (US); Brian Patrick Houlihan, San Jose, CA (US); William Gordon Kamdar Cohen, Tiburon, CA (US); Ritchard Gabriel Cisneros, San Luis Obispo, CA (US)

(21) Appl. No.: 13/019,187

(22) Filed: Feb. 1, 2011

Related U.S. Application Data
(60) Provisional application No. 61/300,942, filed on Feb. 3, 2010.

(51) Int. Cl. A63H 33/00; B31B 49/00

(52) U.S. Cl. 229/116.1; 493/84

(57) ABSTRACT

An expandable piñata includes a plurality of legs, each leg comprising a plurality of triangular panels hingeably connected via hinge lines, each triangular panel having a proximal end and a terminal end, the terminal ends of the triangular panels converge, and each triangular panel including an inner and an outer surface; each leg hingeably adjustable between a first, substantially flat configuration, and a second expanded configuration in which the inner surfaces of the triangular panels define a cavity; each leg further including one or more tabs hingeably connected to the proximal ends of the one or more triangular panels, and a tab connected to a triangular panel of a first leg coupled to a tab connected to a triangular panel of an adjacent leg; and a locking device connected to two of the plurality of legs and configured to maintain the plurality of legs in the expanded configuration.

### CROSS REFERENCE TO RELATED APPLICATION

This application claims the benefit of U.S. provisional patent application 61/300,942 filed Feb. 3, 2010 under 35 U.S.C. 119. U.S. provisional patent application 61/300,942 is incorporated by reference herein as though set forth in full.

### FIELD OF THE INVENTION

The field of the invention relates, in general, to piñatas, and, in particular, to expandable piñatas.

### BACKGROUND OF THE INVENTION

Piñatas are popular, especially among children, at parties and other festive occasions. Piñata-breaking celebrations are quite popular in Mexico and in the Mexican-American communities of the Southwestern United States. Piñatas are traditionally a pot or container ornamented with colorful paper and filled with candy, nuts, confetti, and/or token gifts such as small toys and the like. The container is suspended from above and the children, while blindfolded, take turns attempting to puncture the container with a bat or other implement to release the treats within. The traditional piñata is made of clay pottery. More recently, piñatas are constructed of paper mache or other frangible material and generally include a bottom paper closure which is torn or broken by the child pulling a cord or similar attachment secured to the closure, or otherwise breaking the closure.

Typical mass-produced piñatas are constructed of paper mache and assume their full form prior to shipping. The piñata may be filled with treats, but are more commonly sold empty. The hollow paper mache construction of the piñata is relatively fragile and susceptible to breakage during shipping and handling.

A general problem with piñatas in the past is that their large and unusual sizes make shipping expensive.

A need exists for an expandable piñata that may be shipped in a small, flat, two-dimensional configuration and may later be expanded into a large piñata for use at the party or other festive occasion.

### SUMMARY OF THE INVENTION

To overcome the above problems and others, an aspect of the invention involves an expandable and collapsible piñata. The piñata is collapsible for reducing the piñata to a small, compact, flat, substantially two-dimensional configuration that is ideal for shipping because of the greatly reduced shipping costs. The piñata is quickly and easily expandable into a large piñata configuration for normal piñata use at a party or other festive occasion.

Another aspect of the invention involves a piñata that is far more marketable than traditional piñatas because of their huge increase in size at their point of sale. The piñata's size can be reduced greatly when it is getting shipped, and then include a method of expanding it via minimum assembly by either the Point of Sale or the end consumer. The amount of increase is unmatched, and the end product resembles the “true” size of what a piñata should be, not the tiny piñatas that are currently available for mass distribution. This greatly reduces the shipping cost and incorporates many innovative aspects. The heart of this invention is the ability to provide a 3D piñata with a look and size that resembles traditional piñatas while overcoming the caveats posed by high shipping costs via size reduction at the time of transport.

The invention will overcome high shipping costs associated with shipping piñatas of a more traditional size while staying truer to the shapes and feel of what is known as a piñata by most Hispanic peoples. Because shipping costs are a necessary part to any mass distributed piñata operation, industry participants have to deal with the shipping costs in one way or another. Current industry solutions include making/selling smaller piñatas as well as a two-dimensional looking piñatas that does provide some expandability but lacks the complete feel, size, and three-dimensional shape of what is traditionally known as a piñata. The two-dimensional shape addresses the shipping size issue but it merely provides a flat surface on which to apply a large sticker.

The invention, which greatly reduces costs, greatly increases size, and significantly improves enjoyment, will revolutionize the piñata industry and will help spread the piñata culture all across the globe. Large retailers, party suppliers, as well as end consumers will replace their current purchase choices for the money saving, size increasing, enjoyment improving option created by the invention. Shipping goes from being a problem to being a selling point. The invention also makes it possible to improve the current speed, quality control, and cost at which piñatas are actually made, let alone distributed. The mechanisms which allow the piñatas to increase in size also imply and require a new methodology for manufacturing the piñatas which may help with these other considerations (cost of production, speed of production, quality control) inherent in the process of taking raw materials to a finished product in the consumer's home.

The invention embodies the small advantageous size for shipping, the large desirable size for usage, and the three-dimensional feel for enjoyment and authenticity.

Another aspect of the invention involves an expandable piñata includes a plurality of legs, each leg comprising a plurality of triangular panels hingeably connected via hinge lines, each triangular panel having a proximal end and a terminal end, the terminal ends of the triangular panels converge, and each triangular panel including an inner and an outer surface; each leg hingeably adjustable between a first, substantially flat configuration, and a second expanded configuration in which the inner surfaces of the triangular panels define a cavity; each leg further including one or more tabs hingeably connected to the proximal ends of the one or more triangular panels, and a tab connected to a triangular panel of a first leg coupled to a tab connected to a triangular panel of an adjacent leg; and a locking device connected to two of the plurality of legs and configured to maintain the plurality of legs in the expanded configuration.

One or more implementations of the aspect of the invention described immediately above include one or more of the following. An expansion of the plurality of legs from their respective flat configurations to their respective expanded configurations is about a central axis. The plurality of the legs comprise cardboard. The cardboard comprises E-flute cardboard. The outer surface of one or more of the triangular panels of one or more of the legs comprises an ornamental covering. The tassels are connected to the terminal ends of one or more of the triangular patterns of one or more of the legs. The expandable piñata includes one or more tensors configured to bias one or more of the plurality of the legs towards the expanded configuration. The one or more legs comprise a reinforcing layer. The locking device comprises: a flap comprising double sided tape attached to one of the two legs; and a flap comprising hooks attached to the other of the two legs. The locking device comprises one or more ties coupled to each of the two of the plurality of legs.

A further aspect of the invention involves a method of manufacturing an expandable piñata. The method includes forming a plurality of leg workpieces from one or more blanks, each leg workpiece comprising a plurality of hinge lines defining a plurality of triangular panels, each of the triangular panels comprising an inner and an outer surface, each triangular panel having a proximal end and a terminal end, wherein the terminal ends of the triangular panels converge, each leg workpiece further comprising a hinge line defining a side tab adjacent to one of the plurality of triangular panels, each leg workpiece further comprising one or more hinge lines defining one or more tabs adjacent to the proximal end of one or more of the plurality of triangular panels; for each leg workpiece, coupling the side tab to one of the plurality of triangular panels of the leg workpiece to form a leg, each leg being hingeably adjustable between a first, substantially flat configuration, and a second expanded configuration in which the inner surfaces of the triangular panels define a cavity; and for each leg workpiece, coupling one or more of the one or more tabs of a first leg workpiece to one or more of the one or more tabs of a second leg workpiece.

One or more implementations of the aspect of the invention described immediately above include one or more of the following. Forming a plurality of leg workpieces comprises pressing the one or more blanks on a die board. The die board comprises a first plurality of blades configured to cut one or more of the leg workpieces from a blank and a second set of blades configured to imprint the hingelins on the leg workpieces. Providing a locking device for maintaining the plurality of legs in the expanded configuration. Inserting one or more tensors into one or more of the plurality of legs, wherein the tensors are configured to bias the legs in the expanded configuration. Each leg piece comprises four triangular panels. Each leg in the expanded configuration is approximately pyramidal in shape. Forming a hole in one of more of the leg pieces for providing access to one or more cavities defined by the plurality of legs in the expanded configuration. Attaching a support to one or more of the legs for suspending the expandable piñata in its expanded configuration.

A still further aspect of the invention involves a method of using an expandable piñata comprising a plurality of adjacent legs, each leg being hingeably adjustable between a first, substantially flat configuration, and a second expanded configuration in which the leg defines a cavity. The method includes expanding each of a plurality of the adjacent legs from the substantially flat configuration to the expanded configuration about a central axis; adding one or more articles to one or more of the cavities defined by the plurality of legs; and engaging a locking device coupled to two of the legs in order to maintain the plurality of legs in the expanded configuration.

### BRIEF DESCRIPTION OF THE DRAWINGS

FIG. 1 is a perspective view of an embodiment of an expandable star piñata in an expanded configuration;

FIG. 2 is a top plan view of the expandable piñata of FIG. 1 shown in an assembled configuration;

FIG. 3 is a partial cross-sectional view of the expandable piñata of FIG. 1 shown in an assembled configuration;

FIG. 4 is a top plan view of the expandable piñata of FIG. 1 shown in a partially assembled configuration;

FIG. 5 is a side-elevational view of the expandable piñata shown in FIG. 4;

FIG. 6 is a side-elevational view of the expandable piñata of FIG. 4 shown in a folded condition/position.

FIG. 7 is a perspective view of another embodiment of an expandable star piñata in an expanded configuration;

FIG. 8 is a top plan view of the expandable piñata of FIG. 7 shown in an assembled configuration;

FIG. 9 is a partial cross-sectional view of the expandable piñata of FIG. 7 shown in an assembled configuration;

FIG. 10 is a top plan view of the expandable piñata of FIG. 7 shown in a partially assembled configuration;

FIG. 11 is a side-elevational view of the expandable piñata shown in FIG. 10;

FIG. 12 is a side-elevational view of the expandable piñata of FIG. 10 shown in a folded condition/position.

FIG. 13 is a side-elevational view of an embodiment of one of the legs of the expandable piñata of FIGS. 7-12 shown in a flat condition/position.

FIG. 14 is a side-elevational view of an embodiment of another leg of the expandable piñata of FIGS. 7-12 shown in a flat condition/position.

FIG. 15 is a side-elevational view of an embodiment of a further leg of the expandable piñata of FIGS. 7-12 shown in a flat condition/position.

### DETAILED DESCRIPTION OF PREFERRED EMBODIMENT OF THE INVENTION

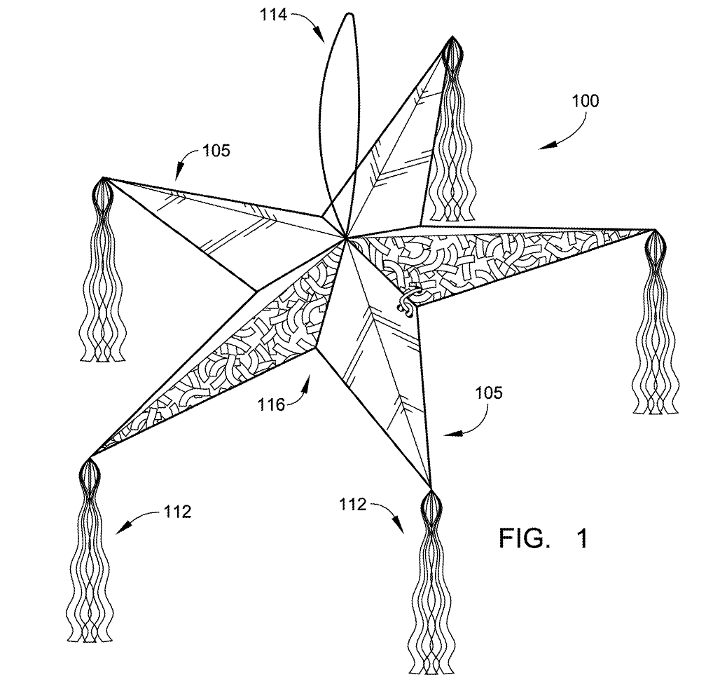

With reference to FIGS. 1-6, embodiment(s) of an expandable star piñata (“piñata”) 100 will be described. The piñata 100 is collapsible for reducing the piñata to a small, compact, flat, substantially two-dimensional configuration (See FIG. 6) for shipping (minimizes shipping costs) and expandable to a large piñata configuration (FIG. 1) for normal piñata use at a party or other festive occasion. Although the piñata 100 is shown in the configuration as a star, in alternative embodiments, the piñata 100 may have other configurations, shapes, characters, and/or designs other than those shown. Further, in alternative embodiments, the piñata 100 may have additional or alternative uses (e.g., decorative uses, star decoration, 4^{th} of July star, Christmas star) and is hung, posted upon a wall/surface, and/or leaned against a wall/surface.

The piñata 100 will first be described generally and then a method of manufacturing the piñata 100 will be described.

With reference to FIG. 1, the piñata 100 preferably includes a plurality of (e.g., five) legs 105 made of single-piece cardboard frame 110. In alternative embodiments, layers and/or multiple pieces of card board may be provided. The frame 110 of each leg 105 is preferably constructed from a sheet of corrugated paper or cardboard, or other similar expedient. The qualities of the particular sheet material necessary for the present invention are that the material be lightweight, easy to form, easy to bend, and somewhat stiff in order to form the structural walls/panels of the frame 110. In one embodiment, the cardboard utilized is approximately ⅛ inch thick so as to be easy to puncture by children hitting the piñata 100 with a bat or other such implement. One particularly desirable material is an E-flute cardboard. In alternative embodiments, other types of cardboard (e.g., C-flute, B-flute) are used. An outer surface of frame 110 may be covered or “dressed” with an ornamental paper, such as paper mache, or other such design so as to conceal the frame 110 within. The colorful paper is preferably adhered to the outer surface of the flat panels. Tassles 112 may be connected to terminal ends of the legs 105.

Although the string, rope, wire, or other support 114 is shown attached to a central hub 116 for supporting/hanging the piñata 100, in a more preferred embodiment, the string, rope, wire, or other support 114 is attached to one of the legs 105.

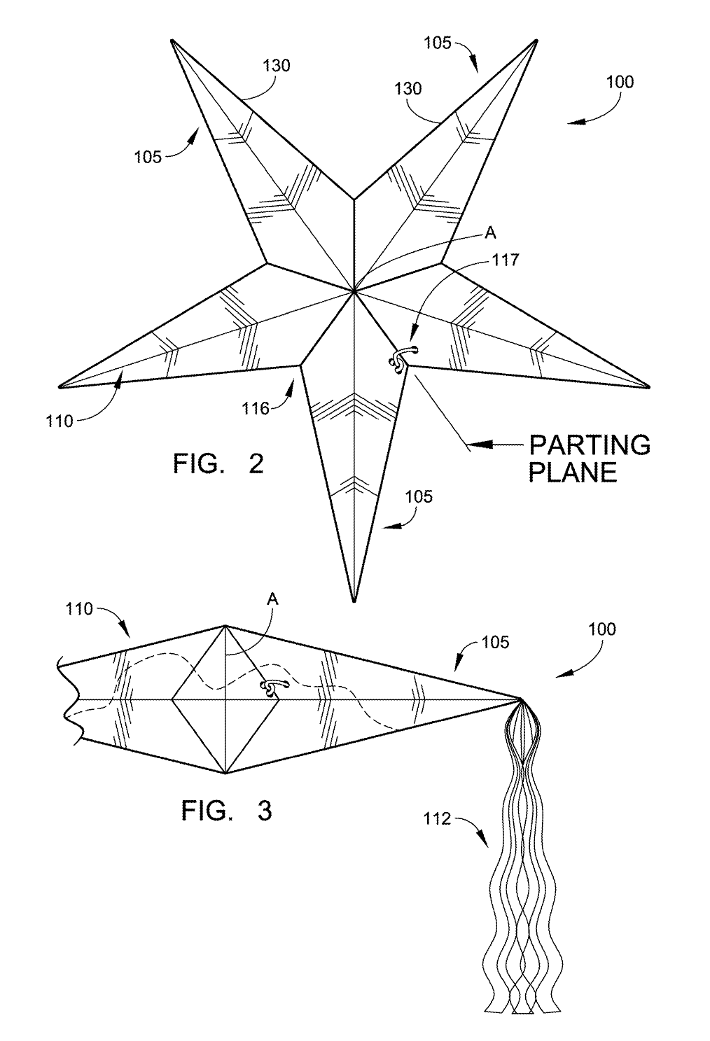

Although a locking device 117 in the form of a tie, string, or cord 118 through holes 119 is shown in the central hub 116 to lock the piñata 100 into the expanded configuration shown in FIGS. 1 and 2, in a more preferred embodiment, as shown below with respect to FIGS. 8-11, the locking device 117 includes two-sided tape and hooks on flaps on the legs 105 where the piñata 100 comes together.

As shown in FIG. 3, an inside of the piñata 100/legs 105 is hollow to hold articles, prizes, candy, nuts, etc.

Each leg 105 of the piñata 105 has a pyramidal configuration with multiple (e.g., four) triangular panels 130 foldably/hingeably connected to each other via hinge lines 132. In alternative embodiments, each leg 105 may include other numbers of panels 130 (e.g., 3, 4, 5, 6, 7, 8, 9, 10, 11, 12, etc.). A rhombus-shaped tab 135 is hingeably connected at a proximal end to the triangular panel 130 via hinge lines 134. The hinge lines 132, 134 form bendable hinges (e.g., simple bends, pre-folded bends, bends formed by scoring the external surface and/or internal surface of the frame 110).

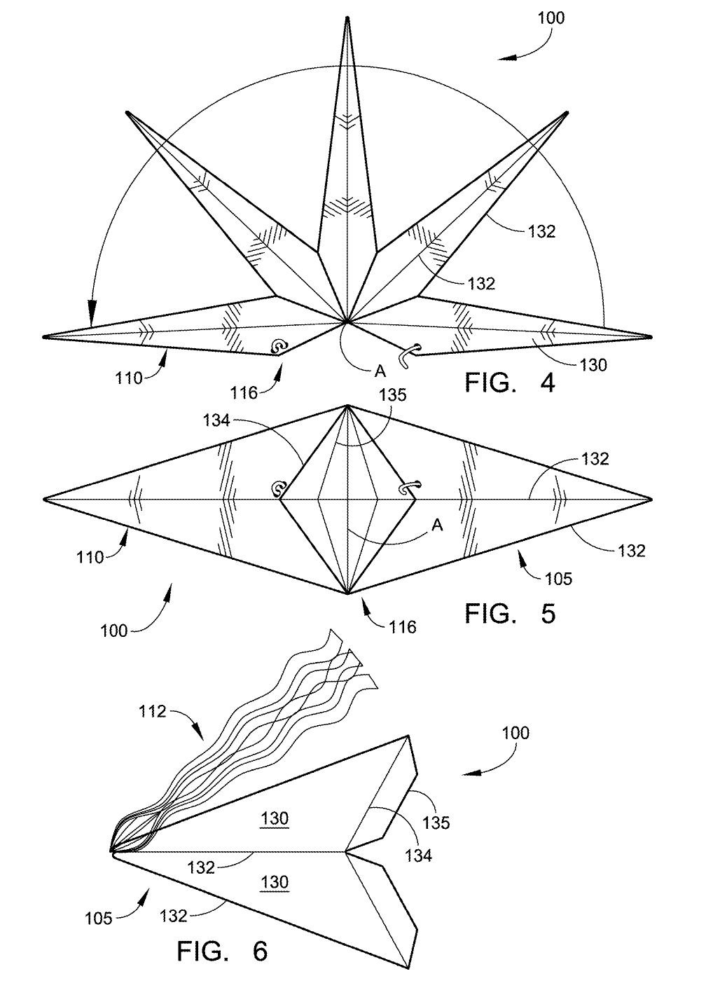

In the expanded configuration (FIGS. 1, 2), the legs 105 assume an expanded pyramidal configuration. In the collapsed configuration (FIG. 6), the legs 105 assume a substantially two-dimensional, flat arrow configuration, which is an ideal configuration for shipping. As shown in FIGS. 4 and 5, the legs fold about a central axis A for folding the piñata 100 between the expanded pyramidal configuration (FIGS. 1, 2) and the collapsed configuration (FIG. 6). As the piñata 100 is folded into the expanded pyramidal configuration (FIGS. 1, 2) and the collapsed configuration (FIG. 6), triangular panels 130 fold about hinge lines 132, 134.

In an alternative embodiment, one or more tensors (not shown) are attached to the leg(s) 105 to urge/bias/pull/guide the piñata 100 into/towards the expanded configuration (FIGS. 1, 2).

In an alternative embodiment, the piñata 100 (or portions of the piñata 100) may be reinforced by one or more layers of plastic material (or plastic/fiber material) to strengthen the piñata 100 and/or strengthen certain areas of the piñata 100. More or less plastic reinforcement may be added to adapt the piñata 100 for different age-specific usage groups in accordance with different strength levels for each group so that the piñata 100 ruptures in accordance with the strength level for that age group.

Although not shown, the piñata 100 may include one or more holes for inserting articles, prizes, candy, nuts, etc. into the cavities (or cavities) formed in piñata 100 for filling the piñata 100.

In use, the piñata 100 is collapsed into the small, compact, flat, substantially two-dimensional, arrow-shaped configuration shown in FIG. 6 (or folded version of FIG. 6) for shipping to minimizes shipping costs, and then removed from the shipping packaging and, when the piñata 100 is ready to be used, the piñata 100 is expanded into the large piñata configuration shown in FIGS. 1, 2 for normal piñata use at a party or other festive occasion.

To expand the piñata 100 from the small, compact, flat, substantially two-dimensional configuration shown in FIG. 6 (or folded version of FIG. 6) to the large piñata configuration shown in FIGS. 1 and 2, the collapsed piñata 100 is folded about the axis A (FIGS. 4, 5) into the expanded configuration shown in FIGS. 1, 2. As the piñata 100 is folded into expanded configuration, the triangular panels 130 fold about hinge lines 132, 134 so that the triangular panels 130 assume the expanded pyramid-shaped legs 105 as the piñata 100 takes on a star-like configuration. As indicated above, in an alternative embodiment, tensors or other urging/biasing members may be provided in the piñata 100 to urge the legs 105 to fold about axis A to the expanded configuration (FIGS. 1, 2).

Outermost legs 105 are locked together in the central hub 116 using locking device 117 (e.g., tie, string, cord 118 through holes 119) to lock the piñata 100 into the expanded configuration shown in FIGS. 1 and 2.

The cavity or cavities of the piñata 100 may be filled by inserting articles, prizes, candy, nuts, etc. through one or more fill holes in the piñata 100.

To collapse the piñata 100 (e.g., for shipping, transport, and/or storage) from the large piñata configuration shown in FIGS. 1 and 2 to the small, compact, flat, substantially two-dimensional configuration shown in FIG. 6 (or folded version of FIG. 6), the locking device 117 is unlocked (e.g., tie, string, cord 118 is cut) and adjacent outermost legs 105 are folded away from each other about the axis A (FIGS. 4, 5) into the collapsed, flat configuration shown in FIG. 6 (or folded version of FIG. 6). As the piñata 100 is folded into collapsed configuration, the triangular panels 130 fold about hinge lines 132, 134 so that the legs 105 assume a flat, substantially two-dimensional configuration.

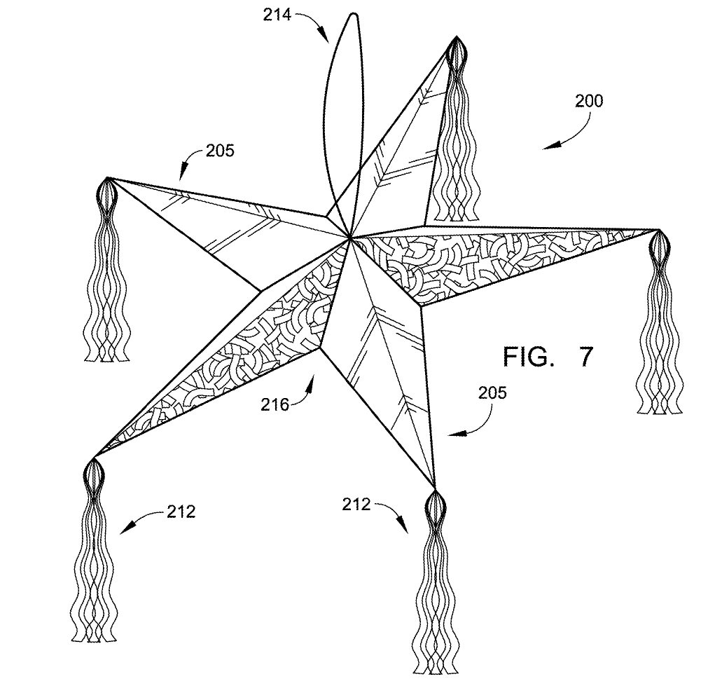

With reference to FIGS. 7-14, another embodiment of an expandable star piñata 200 will be described.

With reference to FIG. 7, the piñata 200 preferably includes a plurality of (e.g., five) legs 205 made of single-piece cardboard frame 210. In alternative embodiments, layers and/or multiple pieces of card board may be provided. The frame 210 of each leg 205 is preferably constructed from a sheet of corrugated paper or cardboard, or other similar expedient. The qualities of the particular sheet material necessary for the present invention are that the material be lightweight, easy to form, easy to bend, and somewhat stiff in order to form the structural walls/panels of the frame 210. In one embodiment, the cardboard utilized is approximately ⅛ inch thick so as to be easy to puncture by children hitting the piñata 200 with a bat or other such implement. One particularly desirable material is an E-flute cardboard. In alternative embodiments, other types of cardboard (e.g., C-flute, B-flute) are used. An outer surface of frame 210 may be covered or “dressed” with an ornamental paper, such as paper mache, or other such design so as to conceal the frame 210 within. The colorful paper is preferably adhered to the outer surface of the flat panels. Tassles 212 may be connected to terminal ends of the legs 205.

String, rope, wire, or other support 214 may be attached to a central hub 216 for supporting/hanging the piñata 200.

With reference to FIGS. 8-12 and 14, instead of tie-type locking device as shown in FIG. 2, a locking device 217 includes a first locking tab 220 with an inner surface with double-sided tape 224 and a second locking tab 226 with an inner surface with doubled-sided tape 227. The locking device 217 extends from a first locking leg 305. Once the piñata 200 is expanded to the position shown in FIGS. 7 and 8, a backing from the doubled sided tape 224 of the first locking fold 222 is removed and the first locking tab 222 is folded over onto (and adhered to) an adjacent second locking leg 405. Then, a backing from the doubled sided tape 230 of the second locking tab 226 is removed and the second locking tab 226 is folded over onto (and adhered to) the adjacent second locking leg 405 as shown in FIG. 8. The locking device 217 is used to lock the piñata 200 into the expanded configuration shown in FIGS. 7 and 8.

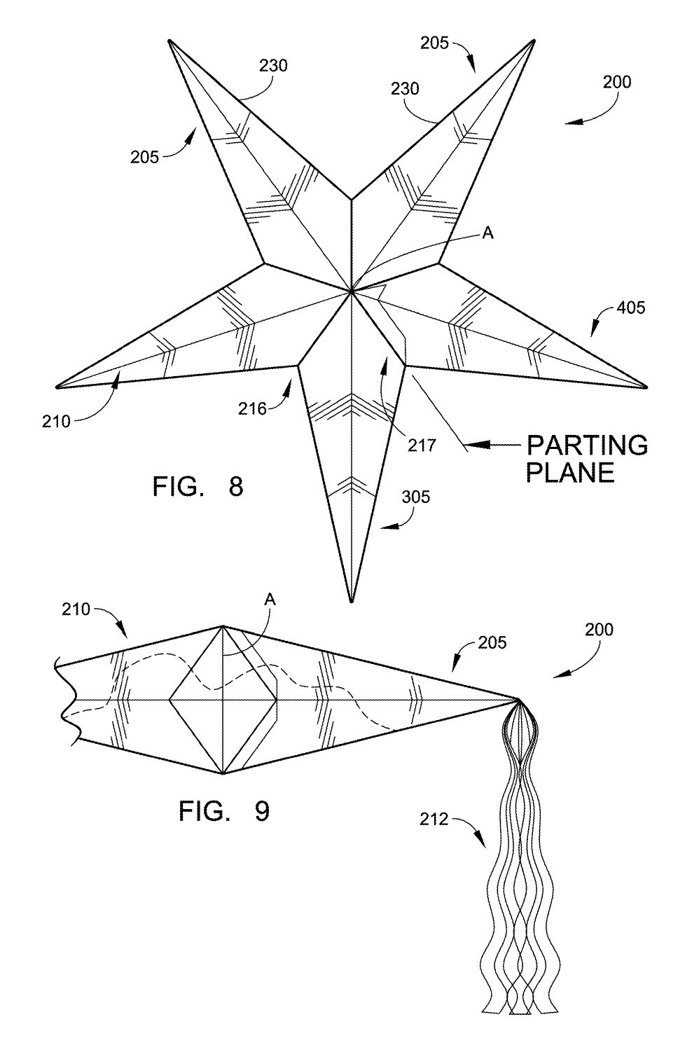

As shown in FIG. 9, an inside of the piñata 200/legs 205 is hollow to hold articles, prizes, candy, nuts, etc.

With reference to FIG. 13, each leg 205 of the piñata 205 has a pyramidal configuration with multiple (e.g., four) triangular panels 230 foldably/hingeably connected to each other via hinge lines 232. In alternative embodiments, each leg 205 may include other numbers of panels 230 (e.g., 3, 4, 5, 6, 7, 9, 10, 11, 12, etc.). A rhombus-shaped end tab 235 is hingeably connected at a proximal end to the triangular panel 230 via hinge lines 234. An elongated rhombus-shaped side tab 237 is hingeably connected at a proximal end to a first end triangular panel 240 via hinge lines 238. The hinge lines 232, 234, 238 form bendable hinges (e.g., simple bends, pre-folded bends, bends formed by scoring the external surface and/or internal surface of the frame 210) The panels/tabs are bent along hinge lines 232, 234, 238 to put the legs 205 into the pyramidal configuration.

The side tab 237 includes double-sided tape 224 (or other adhesive) to form a locking tab. Backing from the doubled sided tape of the side tab 237 is removed (or adhesive is added) and the side tab 237 is folded under or onto, depending on the surface of the side tab 237 including the double-sided tape, a second, opposite end triangular panel 242 so that the side tab 237 is adhered to the second end triangular panel 242 to secure/lock the leg 205 into the pyramidal configuration shown in FIGS. 7-11.

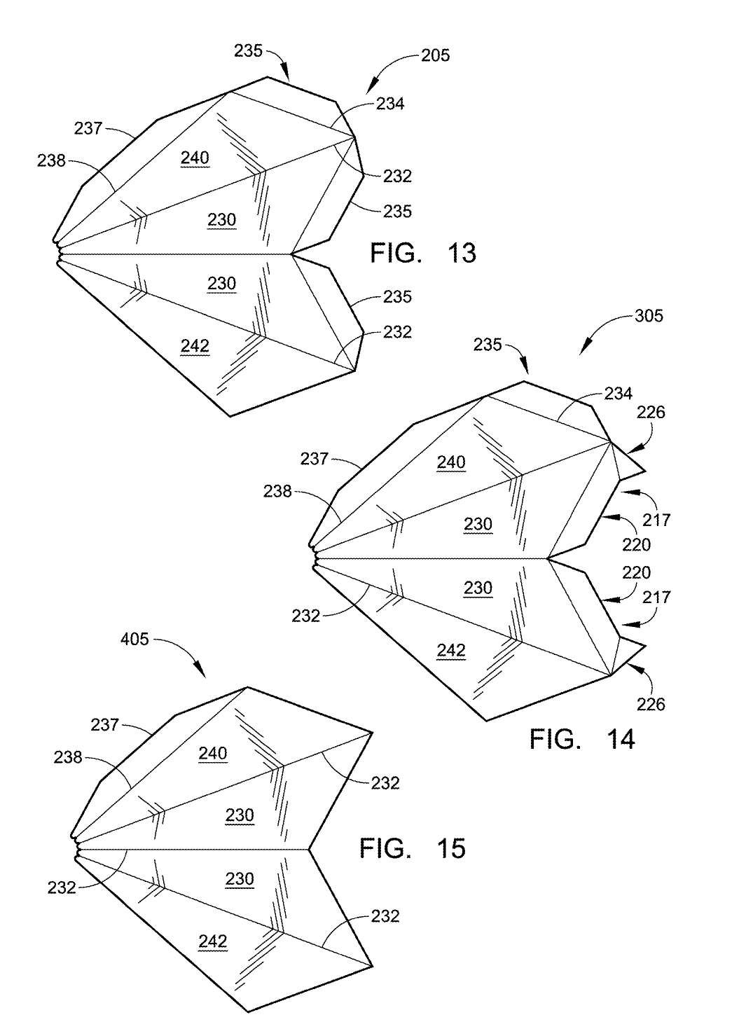

With reference to FIG. 14, a first locking leg 305 is similar to leg 205, except the first locking leg 305 additionally includes the locking device 217 described above for locking the first locking leg 305 to an adjacent second locking leg 405 for locking the piñata 200 into the expanded configuration shown in FIGS. 7 and 8.

With reference to FIG. 15, the second locking leg 405 is similar to leg 205, except the second locking leg 405 does not include rhombus-shaped end tabs 235 nor hinge lines 234.

In the expanded configuration (FIGS. 7, 8), the legs 205 assume an expanded pyramidal configuration. In the collapsed configuration, the legs 205, 305 assume a substantially two-dimensional, flat, arrow shaped configuration (FIG. 12) or a substantially two-dimensional, flat, fan-shaped configuration (FIGS. 13, 14, 15), both of which are ideal configurations for shipping.

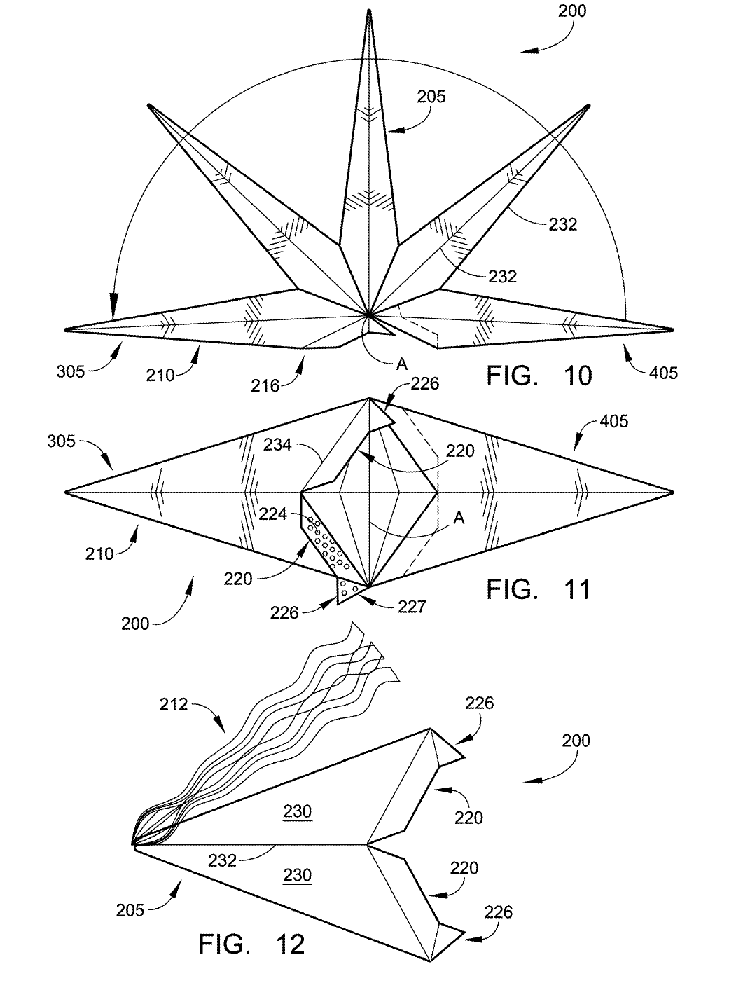

As shown in FIGS. 8 and 10, the legs 205, 305 fold about a central axis A for folding the piñata 200 between the expanded pyramidal configuration (FIGS. 7, 8) and the collapsed configuration (FIG. 12). As the piñata 200 is folded into the expanded pyramidal configuration (FIGS. 7, 8) and the collapsed configuration (FIG. 12), triangular panels 230, 240, 242 fold about hinge lines 232, 234.

In an alternative embodiment, one or more tensors (not shown) are attached to the leg(s) 205, 305 to urge/bias/pull/guide the piñata 200 into/towards the expanded configuration (FIGS. 7, 8).

In an alternative embodiment, the piñata 200 (or portions of the piñata 200) may be reinforced by one or more layers of plastic material (or plastic/fiber material) to strengthen the piñata and/or strengthen certain areas of the piñata 200. More or less plastic reinforcement may be added to adapt the piñata 200 for different age-specific usage groups in accordance with different strength levels for each group so that the piñata 200 ruptures in accordance with the strength level for that age group.

Although not shown, the piñata 200 may include one or more holes for inserting articles, prizes, candy, nuts, etc. into the cavities (or cavities) formed in piñata 200 for filling the piñata 200.

In use, the piñata 200 is collapsed into the small, compact, flat, substantially two-dimensional configuration (FIGS. 12, 13, 14, 15) for shipping to minimize shipping costs, and then removed from the shipping packaging and, when the piñata 200 is ready to be used, the piñata 200 is expanded into the large piñata configuration shown in FIGS. 7, 8 for normal piñata use at a party or other festive occasion.

To expand the piñata 200 from the small, compact, flat, substantially two-dimensional configuration shown in (FIGS. 12, 13, 14) to the large piñata configuration shown in FIGS. 7 and 8, the collapsed piñata 200 is folded about the axis A (FIGS. 8, 10, 11) into the expanded configuration shown in FIGS. 7, 8. As the piñata 200 is folded into expanded configuration, the triangular panels 230, 240, 242 fold about hinge lines 232, 234 so that the triangular panels 230 assume the expanded pyramid-shaped legs 205 as the piñata 200 takes on a star-like configuration. As indicated above, in an alternative embodiment, tensors or other urging/biasing members may be provided in the piñata 200 to urge the legs 205, 305 to fold about axis A to the expanded configuration (FIGS. 7, 8).

Outermost legs 305, 405 are locked together using locking device 217 (e.g., tabs 220, 226, double-sided tape 224, 230) to lock the piñata 200 into the expanded configuration shown in FIGS. 7 and 8.

The cavity or cavities of the piñata 200 may be filled by inserting articles, prizes, candy, nuts, etc. through one or more fill holes in the piñata 200.

String, rope, wire, or other support 238 (FIG. 7) is attached to the central hub 216 (or another location, e.g., leg(s) 205) for supporting/hanging the piñata 200.

To collapse the piñata 200 (e.g., for shipping, transport, and/or storage) from the large piñata configuration shown in FIGS. 7 and 8 to the small, compact, flat, substantially two-dimensional configuration shown in FIG. 12, the locking device 217 is unfastened/unlocked and adjacent outermost legs 305, 405 are folded away from each other about the axis A (FIGS. 8, 10, 11) into the collapsed, flat configuration shown in FIG. 12). As the piñata 200 is folded into collapsed configuration, the triangular panels 230, 240, 242 fold about hinge lines 232, 234 so that the legs 205, 305, 405 assume a flat, substantially two-dimensional configuration.

To manufacture the piñata 100, 200 of the present invention, five separate blanks of cardboard are cut into the two-dimensional leg configurations shown in FIGS. 13, 14, 15. The legs 105, 205, 305, 405 are joined together at the hub to form the frame 110, 210. The particular shape of each leg 105, 205, 305, 405 may be formed by a variety of methods, but a particularly desirable method is to utilize a die board.

A die board typically comprises a large substrate, such as wood, with a plurality of sharp, razor-like blades placed therein at a particular pattern. The blades can be straight or curved, depending on the pattern. The various hinge/fold lines (e.g., hinge lines 132, 134, 232, 234, etc.) may be formed by rounded blades disposed at the same height as the cutting blades. The rounded blades thus imprint a depression in the normally corrugated cardboard to create lines of weakness in bending. Cuts can be made by using blades with a series of intermittent teeth, thus creating a dashed line cut.

When using a flat die, the knives are positioned pointing upward from a flat board and the cardboard blank pressed downward upon them. Typically, foam or rubber inserts are positioned adjacent the knives to facilitate release of the cut cardboard there from. The foam inserts have a height approximately equal to the height of the cutting knives, and the cardboard compresses the foam when pressed down upon the knives. The compressed inserts resiliently expand on release of the pressing force to push the cardboard off the knives. Holes 119 may be punched out in the desired locations for locking device 117 for the embodiment of the piñata 100 shown in FIGS. 1-6.

In an alternative/further embodiment, double-sided tape members such as those shown in FIG. 11 are positioned at various strategic locations for joining outermost legs 105, 305, 405 together. A peel-off backing is removed from one side or both sides of double-sided tape members for joining outermost legs 105, 305, 405 together.

Optional tensors are attached to an inner surface of the legs 105, 205, 305, 405 by fasteners or adhesive.

To dress the piñata 100, 200, glue is applied to the exterior side of the fully formed frame 110, 210 and paper or other material is applied to the glue.

Tassels 112, 212 may be connected to terminal ends of the legs 105, 205, 305 using glue or fasteners.

Thus, the piñata 100, 200 is collapsible for reducing the piñata 100, 200 to a small, compact, flat, substantially two-dimensional configuration that is ideal for shipping because of the greatly reduced shipping costs. The piñata 100, 200 is expandable into a large piñata configuration for normal piñata use at a party or other festive occasion.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. An expandable piñata, comprising:
a plurality of legs, each leg comprising a plurality of triangular panels hingeably connected to each other via hinge lines forming bendable hinges, each triangular panel having a proximal end and a terminal end, the terminal ends of the triangular panels converge, and each triangular panel including an inner and an outer surface,
each leg hingeably adjustable between a first, substantially flat configuration, and a second expanded configuration in which the inner surfaces of the triangular panels define a cavity,
each leg further including one or more tabs hingeably connected to the proximal ends of the one or more triangular panels, and a tab connected to a triangular panel of a first leg coupled to a tab connected to a triangular panel of an adjacent leg; and
a locking device connected to two of the plurality of legs and configured to maintain the plurality of legs in the expanded configuration.

2. The expandable piñata of claim 1, wherein an expansion of the plurality of legs from their respective flat configurations to their respective expanded configurations is about a central axis.

3. The expandable piñata of claim 1, wherein the plurality of the legs comprise cardboard.

4. The expandable piñata of claim 3, wherein the cardboard comprises E-flute cardboard.

5. The expandable piñata of claim 1, wherein the outer surface of one or more of the triangular panels of one or more of the legs comprises an ornamental covering.

6. The expandable piñata of claim 1, wherein the tassels are connected to the terminal ends of one or more of the triangular patterns of one or more of the legs.

7. The expandable piñata of claim 1, further comprising one or more tensors configured to bias one or more of the plurality of the legs towards the expanded configuration.

8. The expandable piñata of claim 1, wherein the one or more legs comprise a reinforcing layer.

9. The expandable piñata of claim 1, wherein the locking device comprises:
a flap comprising double sided tape attached to one of the two legs; and
a flap comprising hooks attached to the other of the two legs.

10. The expandable piñata of claim 1, wherein the locking device comprises one or more ties coupled to each of the two of the plurality of legs.

11. A method of manufacturing an expandable piñata, the method comprising:
forming a plurality of leg workpieces from one or more blanks, each leg workpiece comprising a plurality of hinge lines defining a plurality of triangular panels, each of the triangular panels comprising an inner and an outer surface, each triangular panel having a proximal end and a terminal end, wherein the terminal ends of the triangular panels converge, each leg workpiece further comprising a hinge line defining a side tab adjacent to one of the plurality of triangular panels, each leg workpiece further comprising one or more hinge lines defining one or more tabs adjacent to the proximal end of one or more of the plurality of triangular panels;
for each leg workpiece, coupling the side tab to one of the plurality of triangular panels of the leg workpiece to form a leg, each leg being hingeably adjustable between a first, substantially flat configuration, and a second expanded configuration in which the inner surfaces of the triangular panels define a cavity; and,
for each leg workpiece, coupling one or more of the one or more tabs of a first leg workpiece to one or more of the one or more tabs of a second leg workpiece.

12. The method of claim 11, wherein forming a plurality of leg workpieces comprises pressing the one or more blanks on a die board.

13. The method of claim 12, wherein the die board comprises a first plurality of blades configured to cut one or more of the leg workpieces from a blank and a second set of blades configured to imprint the hingelins on the leg workpieces.

14. The method of claim 11, providing a locking device for maintaining the plurality of legs in the expanded configuration.

15. The method of claim 11, further comprising inserting one or more tensors into one or more of the plurality of legs, wherein the tensors are configured to bias the legs in the expanded configuration.

16. The method of claim 11, wherein each leg piece comprises four triangular panels.

17. The method of claim 16, wherein each leg in the expanded configuration is approximately pyramidal in shape.

18. The method of claim 11, further comprising forming a hole in one of more of the leg pieces for providing access to one or more cavities defined by the plurality of legs in the expanded configuration.

19. The method of claim 11, further comprising attaching a support to one or more of the legs for suspending the expandable piñata in its expanded configuration.

20. A method of using an expandable piñata comprising a plurality of adjacent legs, each leg being hingeably adjustable between a first, substantially flat configuration, and a second expanded configuration in which the leg defines a cavity, the method comprising:
expanding each of a plurality of the adjacent legs from the substantially flat configuration to the expanded configuration about a central axis;
adding one or more articles to one or more of the cavities defined by the plurality of legs; and
engaging a locking device coupled to two of the legs in order to maintain the plurality of legs in the expanded configuration.
